(19) United States
(12) Patent Application Publication
(10) Pub. No.: US 2007/0014624 A1
(43) Pub. Date: Jan. 18, 2007

(54) Dispenser with magnetized elements

(76) Inventors: Steph Fogelson, Chappaqua, NY (US); Linda Fogelson, Chappaqua, NY (US); Nora Yeung, Kowloon (HK)

Correspondence Address: Michael G. Crilly, Esquire, 104 South York Road, Hatboro, PA, 19040, US

(21) Appl. No.: 11/183,438

(22) Filed: Jul. 18, 2005

(51) Int. Cl. B43K 21/08

(52) U.S. Cl. 401/131

(57) ABSTRACT

A dispenser with magnetic elements is presented. The dispenser includes a cup-shaped container having an exterior and interior surface. Magnetic elements are provided within the container wall or attached to a surface along the container. A composition fill resides within the container and is extendable there from via a rotating knob and screw arrangement or a movable plug. An optional covering, one example being a label, may be attached to the dispenser so as to contact and cover the magnetic elements.

### CROSS REFERENCE TO RELATED APPLICATIONS

None.

### FEDERALLY SPONSORED RESEARCH OR DEVELOPMENT

None.

### BACKGROUND OF INVENTION

1. Field of the Invention

The present invention relates to a dispenser for personal care and beauty products. Specifically, the invention includes a stick-shaped dispenser having a tubular container with a fill therein and at least one magnetic element disposed along the dispenser.

2. Description of the Related Art

A variety of stick dispensers are described and claimed in the related arts. Generally, stick dispensers are tubular shaped and have a waxy compound therein, one example being lip balm. The dispenser protects the otherwise easily deformable compound and facilitates application of the compound by the user.

Stick dispensers may employ either a rotation-based or linear-based mechanism to extend the compound from the tubular-shaped container. Both mechanisms move the compound in a linear fashion along the length of the dispenser.

Rotation-based devices include a knob attached to a screw which communicates with the compound directly or indirectly. The compound is extended from and retracted into the tubular-shaped container by rotation of the knob and screw. Schmidt (U.S. Pat. No. 4,580,920), Woodruff et al. (U.S. Pat. No. 4,369,158), Idec et al. (U.S. Pat. No. 3,907,441), McKinley (U.S. Pat. No. 2,818,167), Braselton (U.S. Pat. No. 2,457,342), Weisenberg (U.S. Pat. No. 2,329,367), Daly (U.S. Pat. No. 2,101,132), Recker (U.S. Pat. No. 1,499,784), and Root (U.S. Pat. No. 1,461,680) are exemplary of the variety of rotation-based dispensers.

Linear-based devices include a plug contacting one end of the compound so that compound and plug are movable within the tubular-shaped container. The compound is extended and retracted when a force is applied to the plug by a finger or comparable object. Braselton (U.S. Pat. No. 2,457,342) is exemplary of linear-based dispensers.

Stick dispensers are compact by design. As such, they are easily lost and misplaced when not in use. The related arts do not provide a means for securing a dispenser to a surface or object, so as to ensure the visibility and locatability of the dispenser.

What is required is a stick dispenser that is easily securable to a surface in a removable fashion when not in use.

### SUMMARY OF INVENTION

An object of the present invention is to provide a stick dispenser that is easily securable to a surface in a removable fashion so as to ensure its visibility and locatability.

The present invention includes a stick dispenser and at least one magnetic element attached thereto. The stick dispenser comprises a cup-shaped container having a wall with an exterior surface and an interior surface. One or more magnetic elements are contained within the wall or attached to the surface thereof. A compound resides within the tubular container and is extendable there from via the rotation of a knob or the linear movement of a plug. An optional covering, one example being a label, may be attached to the exterior surface so as to contact and cover the magnetic elements.

In an alternate embodiment, the stick dispenser may include a tubular container, a closure cap removably attached at a first end of the tubular container, and a base movably attached at a second end of the tubular container. A magnetic element is provided within the cap and/or base with or without magnetic elements along the container wall.

The described invention provides advantages over the related arts. The invention allows the user to store the dispenser at a specific and readily visible location, one example being a locker. The invention is simple, low-cost, and easily manufactured, yet provides a functionality that is sorely needed within the art.

### BRIEF DESCRIPTION OF DRAWINGS

FIG. 1 is a side elevation view of an exemplary embodiment of the present invention removably adhered to a vertical surface via attraction between a magnetic element within the dispenser and a magnetically receptive surface.

FIG. 2 is a sectional view of an embodiment having a magnetic element disposed about the outer surface of the container wall of the stick dispenser.

FIG. 3a is a sectional view for an exemplary embodiment showing four magnetic elements disposed about the outer surface of the stick dispenser.

FIG. 3b is a sectional view for an exemplary embodiment showing a covering disposed about the circumference of the stick dispenser shown in FIG. 3a.

FIG. 3c is a sectional view for an exemplary embodiment showing a single magnetic element completely disposed about the outer circumference of the stick dispenser.

FIG. 3d is a sectional view for an exemplary embodiment showing a covering disposed about the magnetic element shown in FIG. 3c.

FIG. 4 is a sectional view of an embodiment having a magnetic element disposed about the inner surface of the container wall of the stick dispenser.

FIG. 5a is a sectional view for an exemplary embodiment showing four linear-shaped magnetic elements disposed about the inner surface of the stick dispenser.

FIG. 5b is a sectional view for an exemplary embodiment showing a covering disposed about the container wall shown in FIG. 5a.

FIG. 5c is a sectional view for an exemplary embodiment showing a magnetic element completely disposed about the inner surface of the stick dispenser.

FIG. 5d is a sectional view for an exemplary embodiment showing a covering disposed about the container wall shown in FIG. 5c.

FIG. 6 is a sectional view of an embodiment having a magnetic element disposed within the container wall between inner and outer surfaces.

FIG. 7 is a sectional view of an embodiment having a magnetic element disposed within the closure cap at one end of the stick dispenser.

FIG. 8 is a sectional view of an embodiment having a magnetic element disposed within the base at one end of the stick dispenser.

### REFERENCE NUMERALS

1 Magnetized dispenser
2 Closure cap
3 Container
4 Base
5 Compound
6 Screw
7 Container wall
8 Exterior surface
9 Magnetic element
10 Covering
11 Mounting Surface
12 Interior surface
13 Length
14 Stick dispenser
15 First end
16 Second end
17 Gap

### DETAILED DESCRIPTION OF INVENTION

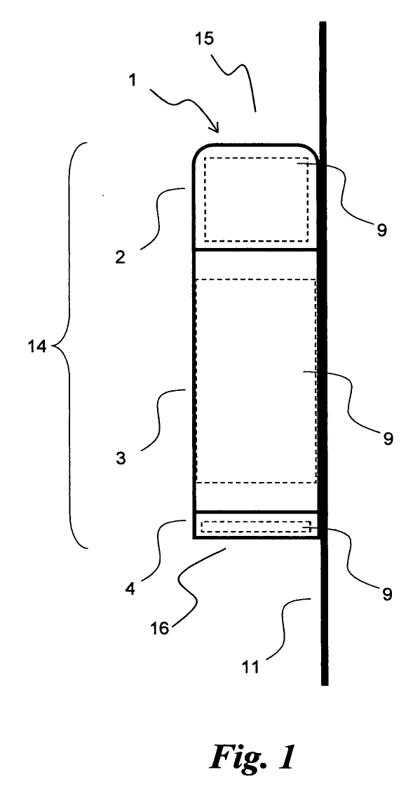

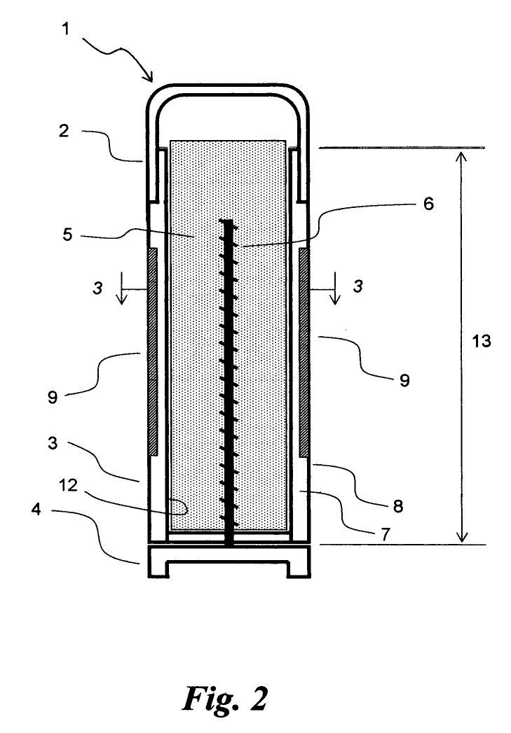

Referring now to FIG. 1, the present invention, generally referred to as a magnetized dispenser 1, is attachable to a metal or other magnetically attractive mounting surface 11. The magnetized dispenser 1 includes a stick dispenser 14 and one or more magnetic elements 9 thereon. The stick dispenser 14 has a substantially tubular-shaped container 3 and may include a closure cap 2 at a first end 15 and a base 4 at a second end 16. The base 4 is a knob for rotation-based devices and a plug for linear-based devices, both being readily understood in the art. While rotation-based devices are shown in FIGS. 2-8 for descriptive purposes, the present invention is equally applicable to linear-based devices and dispensers having fixed or removable brush applicators or the like.

Referring now to FIG. 2, an exemplary magnetized dispenser 1 is shown comprising a cup-shaped and cylindrical container 3 with a base 4 at one end and a closure cap 2 at the other end. A cylinder-shaped compound 5 is likewise shown within the container 3 and contacting threads along a screw 6 oriented along the length 13 of the container 3. The screw 6 passes through a hole within the bottom of the container 3 and thereafter fixed to the base 4. Rotation of the screw 6 is achieved via a corresponding rotation of the base 4 so as to extend the compound 5 beyond the container 3 prior to use, as understood in the art.

The container wall 7 is a substantially tubular-shaped element having an exterior surface 8 and an interior surface 12. One or more magnetic elements 9 are disposed along and mutually contacting the exterior surface 8 opposite of the compound 5.

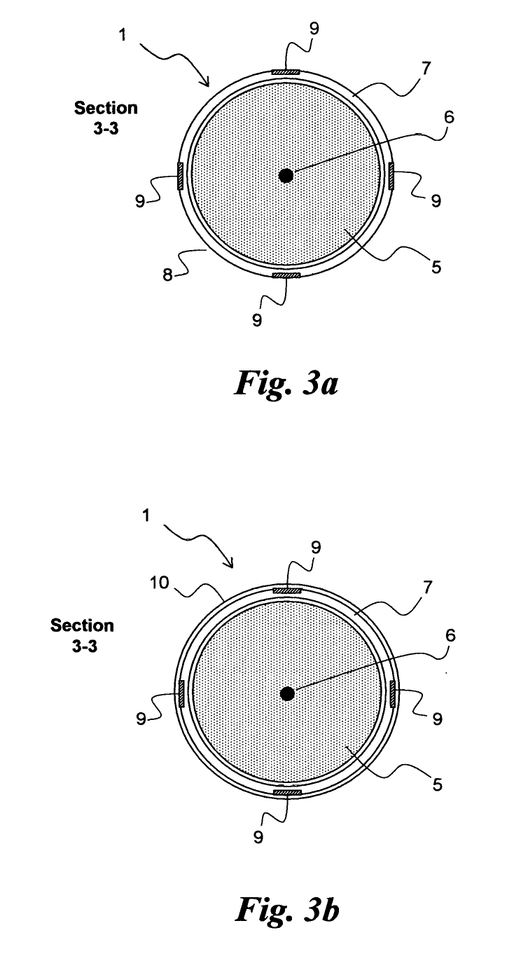

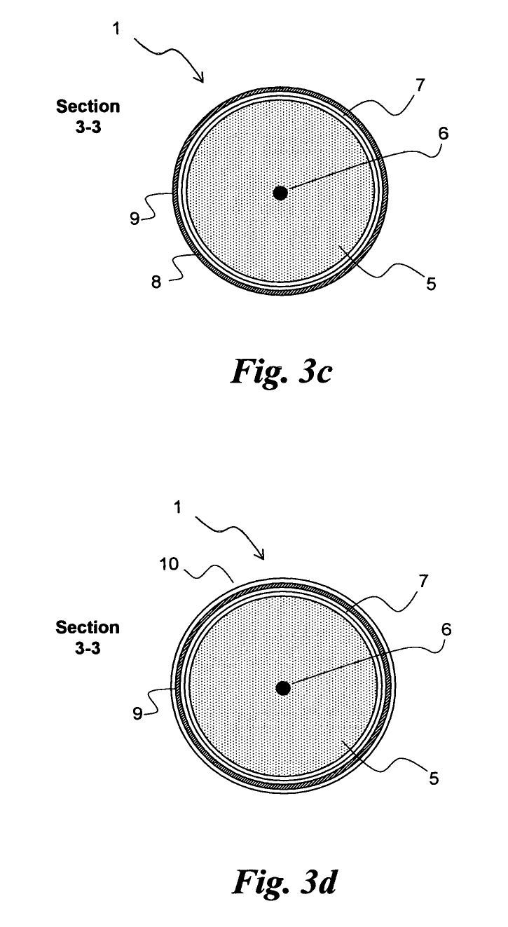

A variety of mounting and attachment schemes are possible. For example, each magnetic element 9 may be recessed within a cavity of nearly identical shape and size so as to ensure the magnetic element 9 does not protrude beyond the profile of the exterior surface 8, as represented in FIG. 3a. It is likewise possible for each magnetic element 9 to extend above the exterior surface 8 or to be flush mounted thereto, the latter represented in FIG. 3c. When recessed within a cavity, each magnetic element 9 may be mechanically fastened to the container wall 7 via an interference fit or adhesively bonded thereto. However, it is preferred to adhesively bond each magnetic element 9 to the container wall 7, when flush mounted to the exterior surface 8. Magnetic elements 9 may extend partially or completely along the length 13 of the container 3.

Magnetic elements 9 may include a variety of commercially available items. However, it is preferred that they be composed of permanent magnet compositions having sufficient magnetism to support the weight of the magnetized dispenser 1 when attracted to a surface. For example, magnetic elements 9 may be flexible or rigid formulations, including without limitation compositions of Neodymium-Iron-Cobalt, Samarium-Cobalt, ceramic with or without binder, AlNiCO, and iron. Magnetic elements 9 may include a variety of thin and shaped designs which either conform to or match the profile of the container wall 7 in part or whole.

Referring now to FIGS. 3a and 3b, two exemplary and non-limiting embodiments of the magnetized dispenser 1 are shown having four linear-shaped magnetic elements 9 disposed about the exterior surface 8 and lengthwise aligned along the container 3. Likewise, it is possible to have as few as one or at least two magnetic elements 9. Magnetic elements 9 may be attached to the container wall 7 mechanically or via an adhesive, as previously discussed. As shown in FIG. 3b, a covering 10 may be applied over the magnetic elements 9 and adhesively bonded to or heat shrunk onto the container wall 7 and/or magnetic elements 9. It is possible for the covering 10 to secure the magnetic elements 9 to the container 3 or further secure the magnetic elements 9 where otherwise mechanically or adhesively attached to the container 3. The covering 10 may be a label, examples including paper and thin-film plastics, having text and graphics thereon.

Referring now to FIGS. 3c and 3d, two exemplary and non-limiting embodiments of the magnetized dispenser 1 are shown having a magnetic element 9 completely traversing the circumference about the exterior surface 8 of the container wall 7. The magnet element 9 may be composed of a single or several similar shaped elements arranged about the container 3. The magnetic element 9 may be attached to the container wall 7 mechanically or via an adhesive, as previously discussed. As shown in FIG. 3d, a covering 10 may be applied over the magnetic elements 9 and adhesively bonded to or heat shrunk onto the container wall 7 and magnetic elements 9. It is possible for the covering 10 to exclusively secure the magnetic elements 9 to the container 3 or further secure the magnetic elements 9 where otherwise attached to the container 3. The covering 10 may be a label, examples including paper and thin-film plastics, having text and graphics thereon.

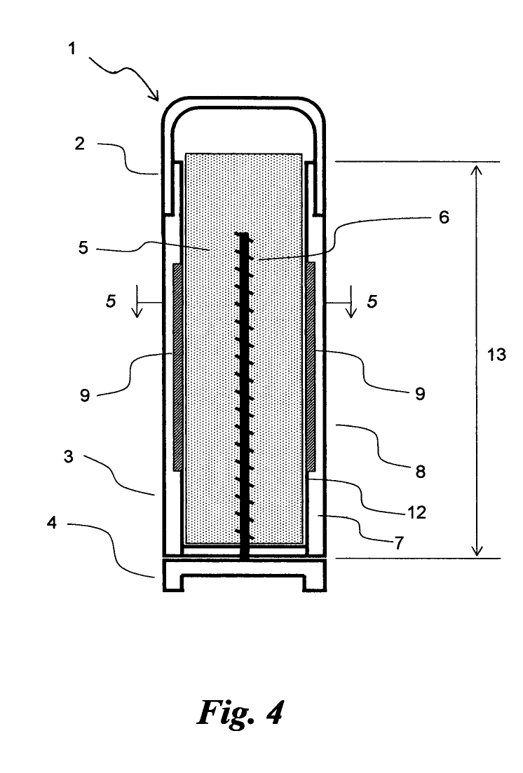

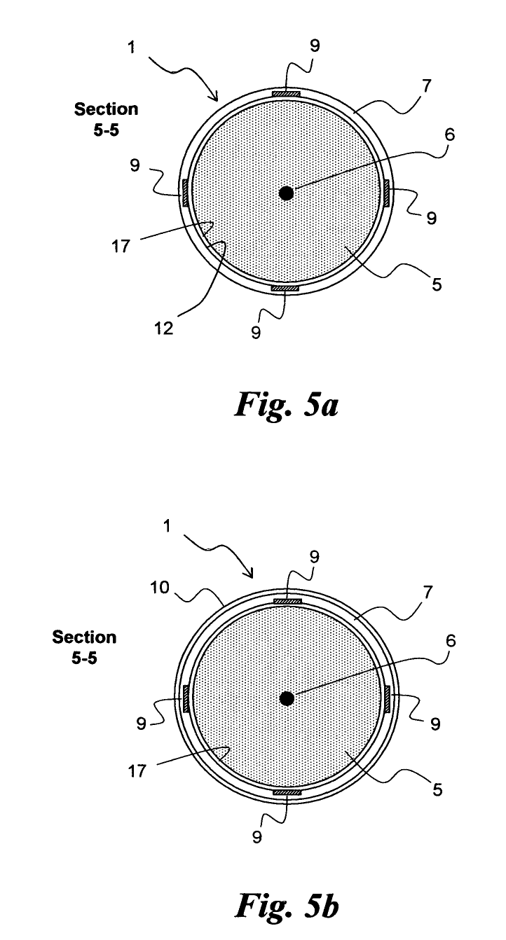

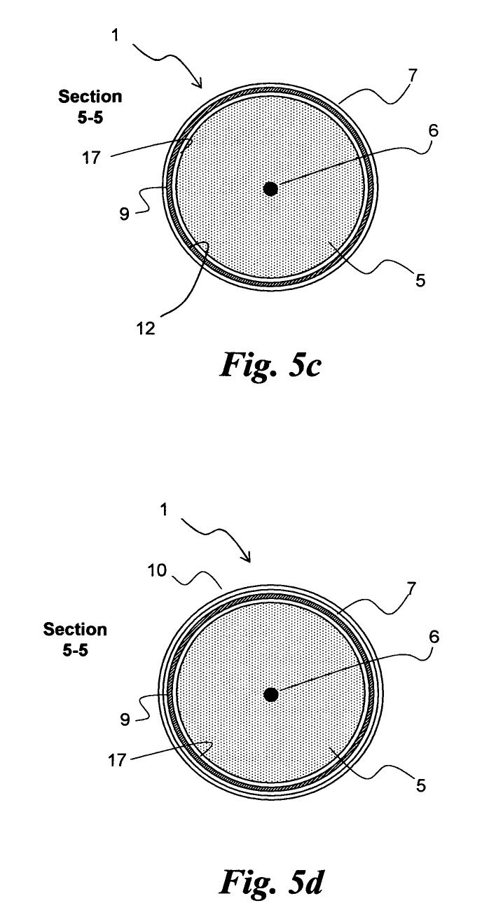

Referring now to FIG. 4, another exemplary and non-limiting embodiment of the magnetized dispenser 1 is shown wherein one or more magnetic elements 9 are disposed along and mutually contacting the interior surface 12 adjacent to the compound 5. A variety of mounting and attachment schemes are likewise possible. For example, each magnetic element 9 may be recessed within a cavity of nearly identical shape and size so as to ensure each magnetic element 9 does not protrude beyond the profile of the interior surface 12, as represented in FIG. 5a. It is likewise possible for each magnetic element 9 to extend above the interior surface 12 or to be flush mounted thereto, the latter represented in FIG. 5c. When recessed within a cavity of mutual shape, each magnetic element 9 may be mechanically fastened to the container wall 7 via an interference fit or adhesively bonded thereto. However, it is preferred to adhesively bond each magnetic element 9 to the container wall 7 when flush mounted to the interior surface 12. Magnetic elements 9 may extend partially or completely along the length 13 of the container 3.

Referring now to FIGS. 5a and 5b, two exemplary and non-limiting embodiments of the magnetized dispenser 1 are shown having four linear-shaped magnetic elements 9 disposed about the interior surface 12 and lengthwise aligned along the container 3. Magnetic elements 9 may be attached to the container wall 7 mechanically or via an adhesive, as previously discussed. It is preferred to have a gap 17 between magnetic elements 9 and compound 5, although not required. A covering 10 may be adhesively bonded to or heat shrunk onto the exterior surface 8 of the container wall 7, as shown in FIG. 5b. The covering 10 may be a label, examples including paper and thin-film plastics, having text and graphics thereon.

Referring now to FIGS. 5c and 5d, two exemplary and non-limiting embodiments of the magnetized dispenser 1 are shown having a magnetic element 9 completely traversing the interior surface 12 of the container wall 7. The magnet element 9 may be composed of a single element or several similar shaped elements arranged end-to-end about the container 3. The magnetic element 9 may be attached to the container wall 7 mechanically or via an adhesive, as previously discussed. It is preferred to have a gap 17 between magnetic elements 9 and compound 5, although not required. As shown in FIG. 5d, a covering 10 may be adhesively bonded to or heat shrunk onto the exterior surface 8 of the container wall 7. The covering 10 may be a label, examples including paper and thin-film plastics, having text and graphics thereon.

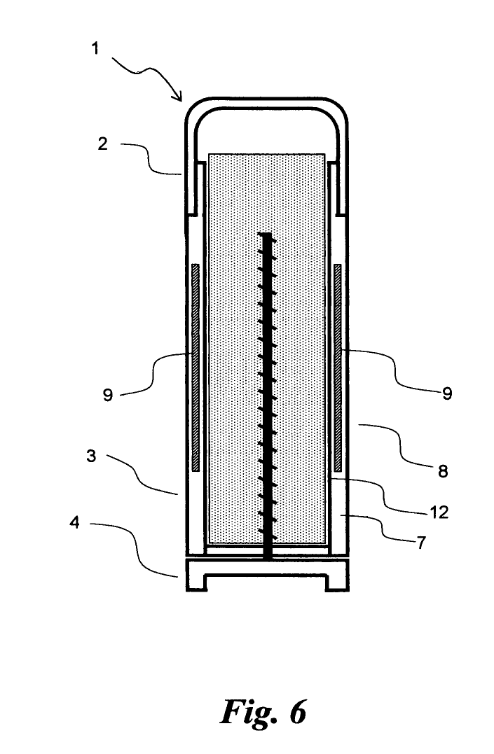

Referring now to FIG. 6, it is likewise possible for the magnetic elements 9 to be encapsulated within the container wall 7 between outer surface 8 and inner surface 12. As such, magnetic elements 9 may be molded within the container wall 7 during fabrication via an injection molding method or other plastic forming method understood in the art. Magnetic elements 9 may extend partially or completely along the length 13 of the container 3.

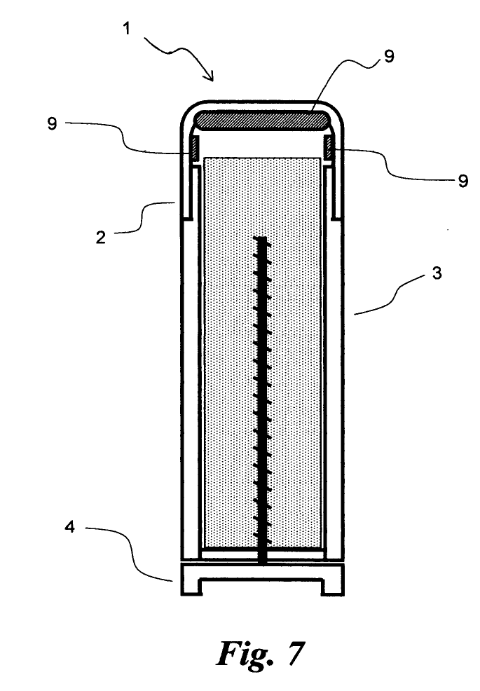

Referring now to FIG. 7, another exemplary and non-limiting embodiment of the magnetized dispenser 1 is shown having a magnetic element 9 attached to the closure cap 2. The magnetic element 9 may be composed of one or more elements mechanically or adhesively attached to the interior or exterior of the closure cap 2, as described above for the container 3. It is likewise possible to have the magnetic element 9 encapsulated within the structure of the closure cap 2. The magnetic element 9 within the closure cap 2 may be used with or without magnetic elements 9 along the container wall 7.

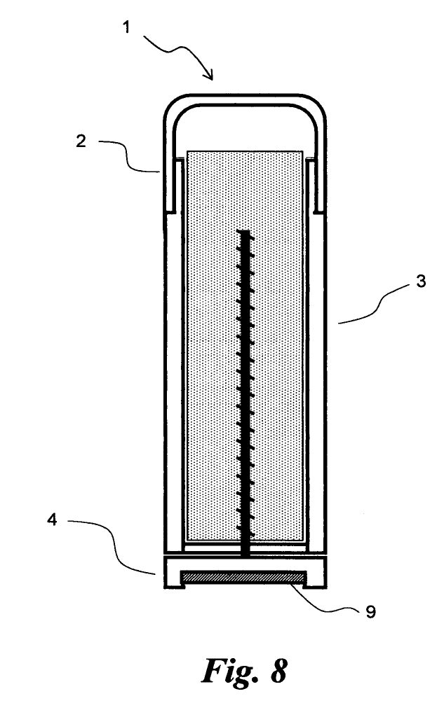

Referring now to FIG. 8, yet another exemplary and non-limiting embodiment of the magnetized dispenser 1 is shown having a magnetic element 9 attached to the interior or exterior of the base 4. Likewise, the magnetic element 9 may be composed of one or more elements mechanically or adhesively attached to the closure cap 2, as described above for the container 3. Furthermore, it is possible to have the magnetic element 9 encapsulated within the structure of the base 4. The magnetic element 9 within the base 4 may be used with or without magnetic elements 9 along the container wall 7 and closure cap 2.

Although magnetized dispensers 1 are shown in FIGS. 2-8 having a solid compound fill therein, the present invention is likewise applicable to containers with fills including waxy compositions, gels, and fluids, examples including lip gloss, lipstick, mascara, and deodorant. Furthermore, the present invention may also include containers having a fixed or removable applicator.

The description above indicates that a great degree of flexibility is offered in terms of the present invention. Although the present invention has been described in considerable detail with reference to certain preferred versions thereof, other versions are possible. Therefore, the spirit and scope of the appended claims should not be limited to the description of the preferred versions contained herein.

What is claimed is:

1. A magnetized dispenser comprising:
(a) a dispenser including a container, said container having a container wall with an exterior surface and an interior surface; and
(b) at least one magnetic element disposed along said container.

2. The magnetized dispenser of claim 1, wherein said magnetic element partially covers said exterior surface.

3. The magnetized dispenser of claim 2, further comprising a covering about said magnetic element and said exterior surface.

4. The magnetized dispenser of claim 1, wherein said magnetic element completely surrounds said exterior surface.

5. The magnetized dispenser of claim 5, further comprising a covering about said magnetic element and said exterior surface.

6. The magnetized dispenser of claim 1, wherein said magnetic element partially covers said interior surface.

7. The magnetized dispenser of claim 6, further comprising a covering about said exterior surface.

8. The magnetized dispenser of claim 1, wherein said magnetic element completely surrounds said interior surface.

9. The magnetized dispenser of claim 8, further comprising a covering about said exterior surface.

10. The magnetized dispenser of claim 1, wherein said magnetic element is disposed within said container wall.

11. The magnetized dispenser of claim 1, further comprising:
(c) a closure cap removably attached at a first end of said container; and
(d) at least one magnetic element disposed along said closure cap.

12. The magnetized dispenser of claim 1, further comprising:
(c) a base at a second end of said container; and
(d) at least one magnetic element disposed along said base.

13. The magnetized dispenser of claim 12, wherein said base is a knob or a plug.

14. The magnetized dispenser of claim 1, wherein said container having a fill therein.

15. A magnetized dispenser comprising:
(a) a dispenser comprising:
(i) a container having a container wall with an exterior surface and an interior surface;
(ii) a closure cap removably attached at a first end of said container; and
(iii) a base movably attached at a second end of said container; and
(b) at least one magnetic element disposed along said closure cap.

16. The magnetized dispenser of claim 15, wherein said base is a knob or a plug.

17. The magnetized dispenser of claim 15, wherein said container having a fill therein.

18. A magnetized dispenser comprising:
(a) a dispenser comprising:
(i) a container having a container wall with an exterior surface and an interior surface;
(ii) a closure cap removably attached at a first end of said container; and
(iii) a base movably attached at a second end of said container; and
(b) at least one magnetic element attached to said base.

19. The magnetized dispenser of claim 18, wherein said base is a knob or a plug.

20. The magnetized dispenser of claim 18, wherein said container having a fill therein.
